(19) United States
(12) Patent Application Publication
(10) Pub. No.: US 2008/0182711 A1
(43) Pub. Date: Jul. 31, 2008

(54) HYBRID DRIVE ARRANGEMENT FOR A VEHICLE WITH A POWERTRAIN

(75) Inventors: Michael Roske, Friedrichshafen (DE); Stefan Kilian, Friedrichshafen (DE); Frank Neumaier, Muehlenbach (DE)

Correspondence Address: DARBY & DARBY P.C., P.O. BOX 770, Church Street Station, New York, NY, 10008-0770, US

(73) Assignee: ZF FRIEDRICHSHAFEN AG, Friedrichshafen (DE)

(21) Appl. No.: 12/020,664

(22) Filed: Jan. 28, 2008

(30) Foreign Application Priority Data
Jan. 30, 2007 (DE) 10 2007 004 459.5

(51) Int. Cl. B60W 20/00

(52) U.S. Cl. 477/5; 477/3

(57) ABSTRACT

A hybrid drive arrangement for a vehicle with a powertrain includes an internal combustion engine, a transmission with a variable gear ratio and defining a driving side and a driven side, at least one electric machine disposed on the driving side and an acceleration element disposed on the driving side of the transmission. The electrical machine is operable as a motor and as a generator, and the acceleration element may include at least one hydrodynamic converter or at least one clutch and at least one gear ratio component.

Priority is claimed to German Patent Application No. DE 10 2007 004 459.5, filed on Jan. 30, 2007, the entire disclosure of which is incorporated by reference herein.

The present invention relates to a hybrid drive arrangement for a vehicle with a powertrain.

### BACKGROUND

For instance, Japanese publication JP 05038956 discloses a hybrid drive arrangement for a vehicle. The powertrain of the vehicle comprises an internal combustion engine that is connected via a clutch to an electric motor that serves as a generator and also as a power source for the vehicle. The electric motor is connected to a battery that can serve as a source of energy during motor operation, that can be charged during generator operation and that serves as a storage system. The electric motor is connected via another clutch to a transmission that provides appropriate gear ratios in order to transmit a desired output speed to the drive shafts of the vehicle.

### SUMMARY OF THE INVENTION

An object of the present invention is to provide a hybrid drive arrangement of the types described above, in which the drive concept, and especially also the acceleration of the vehicle from a standstill, are optimized.

The present invention provides a hybrid drive arrangement for a vehicle with a powertrain that includes an internal combustion engine, a transmission with a variable gear ratio, at least one electric machine arranged on the driving side and an acceleration element whereby, as the acceleration element, at least one hydrodynamic converter is arranged on the driving side of the transmission.

The use of a virtually wear-free acceleration element in the form of a converter means that the vehicle can be operated in a manner that is as maintenance-free as possible. This also entails the advantage that the use of the appropriate converter type makes it possible to adapt the engine characteristics to the requirements of the part being driven. For instance, so-called torque increases are possible during the transmission of the engine torque in each case.

Within the scope of an especially advantageous embodiment variant of the present invention, it can be provided for the hydrodynamic converter to be positioned between the electric machine and the transmission. In this manner, not only the engine torque of the internal combustion engine but also the motor torque of the electric machine can be transmitted via the converter that is provided as the acceleration element. Consequently, the above-mentioned advantages apply in the case of power supplied either purely electrically, only by the internal combustion engine, or else by a combination of both.

In another variant of the invention, the hydrodynamic converter can be connected directly to the output shaft of the internal combustion engine. Other arrangement possibilities are also conceivable. For example, several converters can be provided, so that each drive source is associated with a converter.

In order to expand the drive or acceleration possibilities for the proposed hybrid drive arrangement, the next embodiment of the invention can provide for a clutch—as the acceleration element and/or decoupling element—to be connected to the powertrain. The clutch can be arranged anywhere in the powertrain. Preferably, the clutch can be connected to the output shaft of the internal combustion engine. In this manner, the driven section can be decoupled from the internal combustion engine by opening the clutch. This allows a purely electric drive, even when the internal combustion engine has been switched off. It is also conceivable to additionally provide a clutch on the driving side and/or on the driven side of the hydrodynamic converter. The arrangement on the driving side has the advantage that it allows electric drive operation by decoupling or closing the clutch. The arrangement of the clutch on the driven side, in contrast, has the advantage that the internal combustion engine can be started by the electric machine.

Since a clutch permits a complete decoupling of the powertrain in contrast to the hydrodynamic converter, this arrangement capability can be useful if a complete decoupling of the powertrain is desired.

In addition, the present invention provides a hybrid drive arrangement for a vehicle having a powertrain, whereby at least one clutch and at least one gear ratio component are arranged as the acceleration element on the driving side of the transmission. In this manner, not only can the acceleration process be optimized but the configuration of the drive motors in question can also be changed by selecting the gear ratio component accordingly.

Preferably, a gear ratio component having a constant gear ratio can be used. A spur gear component and/or a bevel gear component or similar can be employed for this purpose.

The above-mentioned arrangement possibilities, embodiments and variants can also be combined with each other as desired, and the number of individual components can likewise be varied.

### BRIEF DESCRIPTION OF THE DRAWINGS

The present invention will be described in greater detail below with reference to the drawings. These show the following:

FIG. 1—a schematic representation of a first embodiment of an inventive hybrid drive arrangement, having an acceleration element located between an electric machine and a transmission;

FIG. 2—a schematic representation of a variant of the first embodiment, having a clutch on the driving side of the electric machine;

FIG. 3—a schematic representation of a variant of the first embodiment, having a clutch on the driven side of the electric machine;

FIG. 4—a schematic representation of a second embodiment of an inventive hybrid drive arrangement, having an acceleration element located on the output shaft of an internal combustion engine; and

FIG. 5—a schematic representation of a third embodiment of an inventive hybrid drive arrangement, having a gear ratio component.

### DETAILED DESCRIPTION

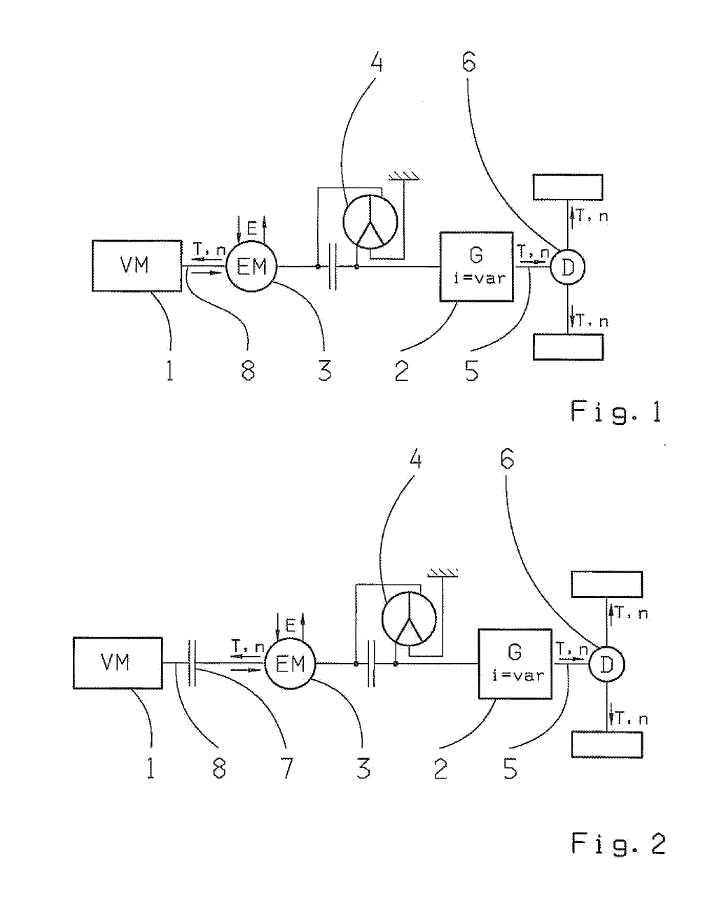

FIGS. 1 to 5 show several embodiments by way of example.

All of the embodiments of the hybrid drive arrangement according to the present invention for a vehicle comprise an internal combustion engine 1, a transmission 2 with a variable gear ratio, an electric machine 3 arranged on the driving side of the transmission 2, whereby said electric machine 3 can be operated as a motor and as a generator.

The first and second embodiments additionally have an acceleration element that is configured as a hydrodynamic converter 4. This hydrodynamic converter 4 is arranged on the driving side of the transmission 2. Finally, the output shaft 5 of the transmission 2 is connected to a differential gear 6 that is arranged on the drive axle of the vehicle.

In the first embodiment of the hybrid drive arrangement according to the invention shown in FIGS. 1 to 3, the hydrodynamic converter 4 is arranged between the electric machine 3 and the transmission 2. In this manner, the engine torque generated by the internal combustion engine 1 as well as the motor torque generated by the electric machine 3 can be transmitted via the hydrodynamic converter 4 to power the vehicle, whereby the corresponding converter type can be used for the torque transmission.

In FIG. 2, a first clutch 7 is additionally provided as an acceleration element and decoupling element. The clutch 7 is connected directly to the output shaft 8 of the internal combustion engine 1. As a result, the internal combustion engine 1 can be uncoupled from the rest of the powertrain by opening the clutch 7. Thus, the vehicle can also be powered only electrically via the machine 3.

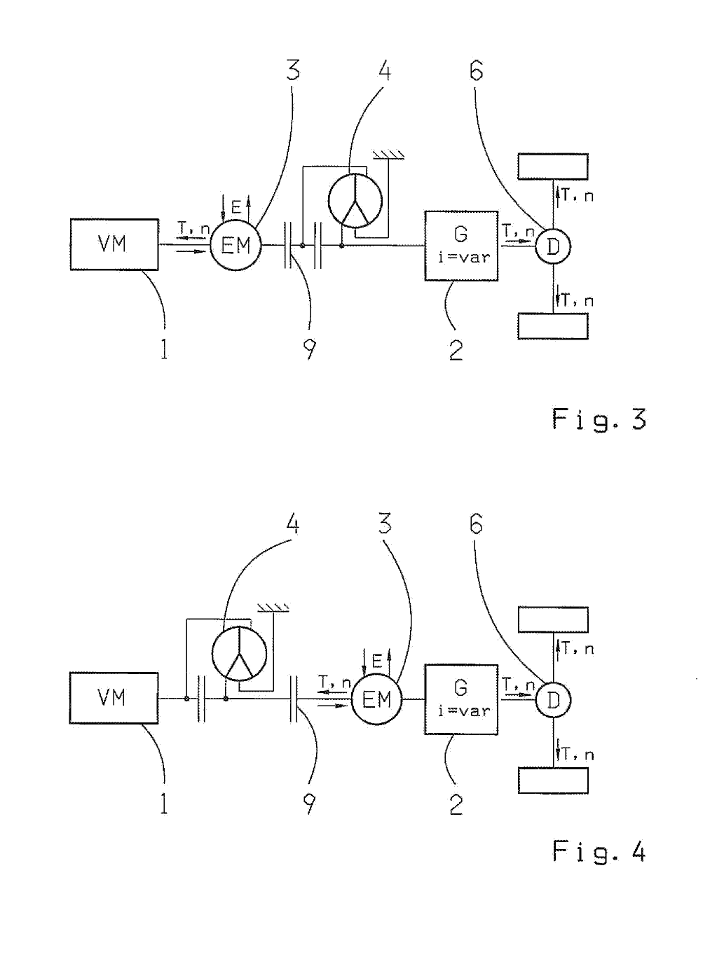

In FIG. 3, a second clutch 9 is arranged as an additional acceleration element and/or decoupling element on the driven side of the electric machine 3 upstream from the hydrodynamic converter 4 in the powertrain. Owing to this arrangement of the clutch 9, when the clutch 9 is open, the internal combustion engine 1 with the electric machine 3 can be uncoupled from the rest of the powertrain, so that the internal combustion engine 1 can be started with the electric machine 3.

FIG. 4 shows the second embodiment of the hybrid drive arrangement according to the invention, in which the hydrodynamic converter 4 is connected directly to the output shaft 8 of the internal combustion engine 1. The second clutch 9 is arranged as an acceleration and/or decoupling element on the driven side of the hydrodynamic converter 4. Therefore, when the clutch 9 is open again, a purely electrical drive is possible by means of the electric machine 3. Moreover, as was the case with the other embodiments, the possibility exists to put the transmission 2 in neutral, so that here, too, the internal combustion engine 1 can be started with the electric machine 3.

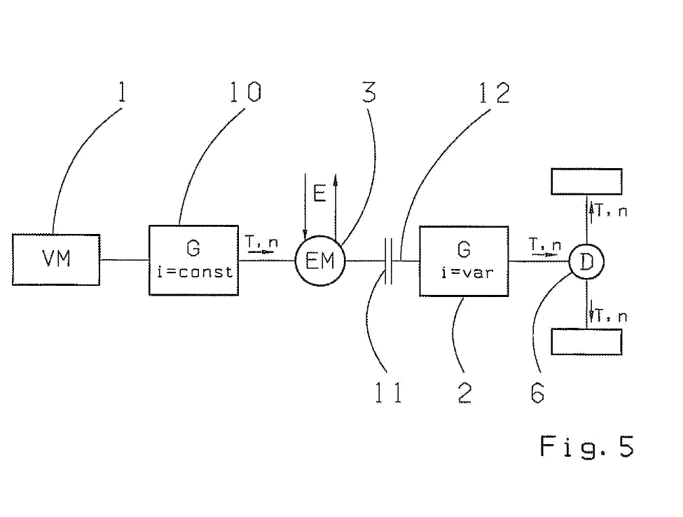

Finally, FIG. 5 shows a third embodiment of the hybrid drive arrangement in which, instead of the converter 4, a clutch 11 is provided as the acceleration element. The clutch is connected to the input shaft 12 of the transmission 2. Furthermore, a gear ratio component 10 is provided between the internal combustion engine 1 and the electric machine 3.

In all of the figures, arrows marked with a “T” and an “n” are used to indicate that a certain torque and a certain rotary speed are being transmitted. Furthermore, arrows marked with an “E” indicate that electrical energy can be picked up and/or emitted.

What is claimed is:

1. A hybrid drive arrangement for a vehicle with a powertrain comprising:
an internal combustion engine;
a transmission with a variable gear ratio and defining a driving side and a driven side;
at least one electric machine disposed on the driving side, the electrical machine operable as a motor and as a generator; and
an acceleration element including at least one hydrodynamic converter disposed on the driving side of the transmission.

2. The hybrid drive arrangement as recited in claim 1, wherein the hydrodynamic converter is disposed between the electric machine and the transmission.

3. The hybrid drive arrangement as recited in claim 1, wherein the hydrodynamic converter is connected to an output shaft of the internal combustion engine.

4. The hybrid drive arrangement as recited in claim 1, further comprising at least one of an additional acceleration element and a decoupling element connected to the powertrain.

5. The hybrid drive arrangement as recited in claim 4, wherein the at least one of an acceleration element and a decoupling element includes a first clutch is connected to an output shaft of the internal combustion engine.

6. The hybrid drive arrangement as recited in claim 1, further comprising a second clutch disposed on the driven side of the electric machine.

7. The hybrid drive arrangement as recited in claim 4, wherein the at least one acceleration element and/or decoupling element includes a second clutch disposed on a driven side of the hydrodynamic converter.

8. A hybrid drive arrangement for a vehicle with a powertrain, comprising:
an internal combustion engine;
a transmission with a variable gear ratio;
at least one electric machine disposed on a driving side of the transmission, the at least one electrical machine being operable as a motor and as a generator;
an acceleration element including at least one clutch and at least one gear ratio component disposed on the driving side of the transmission.

9. The hybrid drive arrangement as recited in claim 8, wherein the gear ratio component has a constant gear ratio.

10. The hybrid drive arrangement as recited in claim 9, wherein the gear ratio component includes at least of a spur gear component and a bevel gear component.
